(19) United States
(12) Patent Application Publication
(10) Pub. No.: US 2009/0074927 A1
(43) Pub. Date: Mar. 19, 2009

(54) Cinnamic Acid To Inhibit Heat- And Light-Induced Benzene Formation In Benzoate-Preserved Carbonated And Non-Carbonated Beverages And Foods While Maintaining Or Improving Product Microbial Stability

(75) Inventors: William Reynolds Bonorden, Brewster, NY (US); Ming Peng, Peekskill, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo, Inc., Purchase, NJ (US)

(21) Appl. No.: 12/212,103

(22) Filed: Sep. 17, 2008

Related U.S. Application Data
(60) Provisional application No. 60/973,199, filed on Sep. 18, 2007.

(51) Int. Cl. A23L 2/44; A23L 2/68

(52) U.S. Cl. 426/330.3; 426/590

(57) ABSTRACT

A beverage product contains a preservative system comprising 20-250 mg/L benzoic acid or salt thereof, 20-250 mg/L sorbic acid or salt thereof, and 10-100 mg/L cinnamic acid or salt thereof where the benzoic acid or salt thereof to sorbic acid or salt thereof mass ratio is greater than 1:1 while the mass ratio of benzoic acid or salt thereof to the total sorbic and cinnamic acids or salts thereof is approximately 1 or less. In particular the preservative blend comprises potassium benzoate, potassium sorbate, and potassium cinnamate.

### CROSS REFERENCE OF RELATED APPLICATION

This application claims benefit of provisional application Ser. No. 60/973,199 filed Sep. 18, 2008. The entire contents of said application is incorporated herein by reference in its entirety.

### FIELD OF THE INVENTION

This invention relates to beverages and other beverage products, such as beverage concentrates, etc. In particular, this invention relates to beverages and other beverage products having formulations containing potassium benzoate, potassium sorbate, and potassium cinnamate.

### BACKGROUND

It has long been known to produce beverages of various formulations. Improved and new formulations are desirable to meet changing market demands.

Current practice is to reduce benzene formation in heat- and light-abused products with the removal or significant reduction of benzoate from the food or beverage system. The loss of antimicrobial activity is then compensated for with the addition of other antimicrobial agents in sufficient quantity to ensure microbiological stability. Thus, reduction of the risk of benzene formation is a function of the decreased benzoate concentration.

The problems with the current practice of reducing or eliminating benzoate are the negative flavor impact of the non-benzoate antimicrobial agents and the potential reduction of the original preservative system's efficacy.

Current practice, in general, uses ratios of benzoate to sorbate salts of 1:1 to 1:1.5 or greater to achieve microbial stability and acceptable benzoate stability. In specific for current practices, the concentration of benzoate and sorbate salts typically range from 100 to 200 ppm and 100 to 300 ppm, respectively.

### BRIEF SUMMARY

In accordance with a first aspect, a benzoate preserved beverage product, such as a beverage, a beverage concentrate, or other product is provided which comprises a benzoic acid or salt thereof, a sorbic acid or salt thereof, and a cinnamic acid or salt thereof.

In accordance with another aspect, a method of preparing a benzoate-preserved beverage product is provided which comprises a benzoic acid or salt thereof, a sorbic acid or salt thereof, and a cinnamic acid or salt thereof.

In accordance with another aspect, a method of inhibiting heat- or light-induced formation in a benzoate-preserved beverage comprises preparing a beverage product including in the beverage product a benzoic acid or salt thereof, a sorbic acid or salt thereof, and a cinnamic acid or salt thereof.

It will be appreciated by those skilled in the art, given the benefit of the following description of certain exemplary embodiments of the beverage and other beverage products disclosed here, that at least certain embodiments of the invention have improved or alternative formulations suitable to provide desirable taste profiles, nutritional characteristics, etc. These and other aspects, features and advantages of the invention or of certain embodiments of the invention will be further understood by those skilled in the art from the following description of exemplary embodiments.

### DETAILED DESCRIPTION OF CERTAIN EXEMPLARY EMBODIMENTS

Cinnamic acid functions as both a free radical scavenger and a preservative. It was discovered that both functionalities can be leveraged to create effective benzoate-containing preservative systems with significantly reduced risk of benzene formation. The present invention allows the use of greater concentrations of benzoate than current practice with less risk of heat- or light-induced benzene formation.

The present invention also allows the creation and use of sorbate, cinnamate and benzoate (or other preservative) blends to preserve beverages and foods with improved flavor profiles relative to benzoate and sorbate alone. The improved preservative blends further allow the stabilization of benzoate in existing benzoate-preserved foods and beverages with less of a flavor profile change than encountered with current practices which is beneficial when reformulating established brands to reduce risk of benzene formation.

Cinnamic acid or cinnamate salt is an effective antimicrobial in both carbonated and non-carbonated beverages. Moreover, Cinnamic acid or cinnamate salt is an effective antioxidant that inhibits benzene formation in heat- and light-abused beverages. Cinnamic acid is used to reduce the risk of benzene formation in heat- and light-abused products by: 1) allowing the reduction of benzoate concentrations in the food system while maintaining functional antimicrobial protection; and 2) acting as an antioxidant that inhibits benzene formation in heat- and light-abused beverages and foods.

Aspects of the present invention are directed to the use of blends of benzoate, sorbate, cinnamate, or other preservatives to produce benzoate stable, effective preservative systems in carbonated and non-carbonated beverages. The present invention provides effective and stable benzoate-containing preservative systems for countries with sorbic acid use restrictions in beverages.

In accordance with the invention, a preservative blend is formed from 20-250 mg/L benzoic acid or salt thereof, 20-250 mg/L sorbic acid or salt thereof, and 10-100 mg/L cinnamic acid or salt thereof. In a further embodiment a preservative blend is formed from 60-200 mg/L benzoic acid or salt thereof, 40-200 mg/L sorbic acid or salt thereof, and 20-75 mg/L cinnamic acid or salt thereof. In a further embodiment a preservative blend is formed from 60-170 mg/L benzoic acid or salt thereof, 40-170 mg/L sorbic acid or salt thereof, 25-50 mg/L cinnamic acid or salt thereof. In all embodiments the ratio of benzoate salt or acid to the sorbate salt or acid is greater than 1 (i.e., the sorbate salt or acid concentration is less than the benzoate salt or acid concentration), and the ratio of benzoate salt or acid to the sum of the sorbate and cinnamate salts or acids is approximately 1 or less (i.e., the sum of the sorbate and cinnamate salt or acid concentrations are approximately equal to the benzoate salt or acid concentration).

In certain aspects of the invention, the preservative blend is prepared from a combination of potassium benzoate, potassium sorbate, and potassium cinnamate.

In accordance with certain aspects of the invention, the benzoate salt to sorbate salt mass ratio is greater than 1:1 while the ratio of benzoate salt to the total sorbate and cinnamate salt mass is approximately 1 or less. In particular, desirable benzoate salt to sorbate salt mass ratios include 7-1.5:1, for example ratios of 6.5:1, 3:1 and 1.5:1 to which the appropriate amount of cinnamate salt is added. These amounts provide significant benzoate stability under significant thermal and light stress.

Suitable benzoate compounds include natural or artificial sodium benzoate, potassium benzoate and benzoic acid.

Suitable sorbate compounds include natural or artificial sodium sorbate, potassium sorbate and sorbic acid.

Suitable cinnamate compounds include natural or artificial sodium cinnamate, potassium cinnamate and cinnamic acid.

In addition to the invention disclosed herein, other conjugated dienes may be used such as, but are not limited to, aliphatic conjugated dienes and salts or derivatives thereof such as 2,4-pentadienoic acid, 2,4-heptadienoic acid, 3,5-heptadienoic acid, and conjugated linoleic acid; phenylpropenoic acids and salts or derivatives thereof such as caffeic acid, para-coumaric acid, ferulic acid, and sinapic acid; and other dieneoic acids and salts and derivatives thereof such as 2-furanacrylic acid, uracanic acid, retinoic acid, 3-(3-pyr) acrylic acid, and 3-(4-pyr) acrylic acid; as well as aromatic conjugated diene-containing compounds such as hinokitiol and resveratrol to further stabilize benzoate or further reduce the sorbate or cinnamate concentrations while maintaining benzoate stability. Resveratrol could be synthetic or, for example, from natural grape seed, polygonum, or red wine extracts. Hinokitiol could be synthetic or from natural cedar oil extracts. The invention includes the use of any combinations of said conjugated dienes to stabilize benzoate within the described invention.

It was also discovered that conjugated diene containing compounds other than sorbate effectively stabilized benzoate alone, e.g., resveratrol and hinokitiol, since this discovery was not obvious to the skilled practitioner the use of these molecules alone or in combination to stabilize benzoate: 1) is not restricted to specific benzoate:sorbate:cinnamate ratios or concentrations as disclosed herein; 2) includes adding these compounds to a beverage product containing a benzoate salt to sorbate salt mass ratio of greater than 1:1 at any concentration necessary to maximize benzoate stability; and 3) includes using these compounds alone to stabilize benzoate (i.e., in the absence of sorbate and or cinnamate salts or acids.

The preservative blend can be used in carbonated and non-carbonated beverages. In particular embodiments, the preservative system is used in carbonated beverages and in beverages not containing tea solids. Carbonated and non-carbonated beverages include ready to drink beverages, juices, juice drinks, sports drinks and isotonics, flavored beverages, flavored beverages with clouds, enhanced waters, flavored waters, coffee drinks, and fortified beverages containing ingredients such as juices, proteins, probiotics, vitamins, and minerals, etc.

The present invention is further directed to a method of preparing a beverage containing benzoic acid or salt thereof, sorbic acid or salt thereof, and cinnamic acid or salt thereof. In particular the method combines potassium benzoate, potassium sorbate, and potassium cinnamate to provide functional benzoate-containing preservative systems that stabilize benzoate from heat- and light-induced degradation.

It should be understood that beverages and other beverage products in accordance with this disclosure may have any of numerous different specific formulations or constitutions. The formulation of a beverage product in accordance with this disclosure can vary to a certain extent, depending upon such factors as the product's intended market segment, its desired nutritional characteristics, flavor profile and the like. For example, it will generally be an option to add further ingredients to the formulation of a particular beverage embodiment, including any of the beverage formulations described below. Additional (i.e., more and/or other) sweeteners may be added, flavorings, colorants, electrolytes, vitamins, fruit juices or other fruit products, tastents, masking agents and the like, flavor enhancers, and/or carbonation typically can be added to any such formulations to vary the taste, mouth feel, nutritional characteristics, etc. In general, a beverage in accordance with this disclosure typically comprises at least water, sweetener, acidulant and flavoring, or in the case of reduced calorie, low calorie and zero-calorie or diet products, water, non-nutritive sweeteners, acidulant and flavoring. Exemplary flavorings which may be suitable for at least certain formulations in accordance with this disclosure include cola flavoring, citrus flavoring, spice flavorings and others. Carbonation in the form of carbon dioxide may be added for effervescence. Certain exemplary embodiments of the beverages disclosed here are cola-flavored carbonated beverages, characteristically containing carbonated water, sweetener, kola nut extract and/or other cola flavoring, caramel coloring, and optionally other ingredients. Additional and alternative suitable ingredients will be recognized by those skilled in the art given the benefit of this disclosure.

The beverage products disclosed here include beverages, i.e., ready to drink liquid formulations, beverage concentrates and the like. Beverages include, e.g., carbonated and non-carbonated soft drinks, fountain beverages, frozen ready-to-drink beverages, coffee beverages, tea beverages, dairy beverages, powdered soft drinks, as well as liquid concentrates, flavored waters, enhanced waters, fruit juice and fruit juice-flavored drinks, sport drinks, and alcoholic products. The terms “beverage concentrate” and “syrup” are used interchangeably throughout this disclosure. At least certain exemplary embodiments of the beverage concentrates contemplated are prepared with an initial volume of water to which the additional ingredients are added. Full strength beverage compositions can be formed from the beverage concentrate by adding further volumes of water to the concentrate. Typically, for example, full strength beverages can be prepared from the concentrates by combining approximately 1 part concentrate with between approximately 3 to approximately 7 parts water. In certain exemplary embodiments the full strength beverage is prepared by combining 1 part concentrate with 5 parts water. In certain exemplary embodiments the additional water used to form the full strength beverages is carbonated water. In certain other embodiments, a full strength beverage is directly prepared without the formation of a concentrate and subsequent dilution.

Water is a basic ingredient in the beverages disclosed here, typically being the vehicle or primary liquid portion in which the remaining ingredients are dissolved, emulsified, suspended or dispersed. Purified water can be used in the manufacture of certain embodiments of the beverages disclosed here, and water of a standard beverage quality can be employed in order not to adversely affect beverage taste, odor, or appearance. The water typically will be clear, colorless, and free from objectionable minerals, tastes and odors, free from organic matter, low in alkalinity and of acceptable microbiological quality based on industry and government standards applicable at the time of producing the beverage. In certain typical embodiments, water is present at a level of from about 80% to about 99.9% by weight of the beverage. In at least certain exemplary embodiments the water used in beverages and concentrates disclosed here is “treated water,” which refers to water that has been treated to reduce the total dissolved solids of the water prior to optional supplementation, e.g., with calcium as disclosed in U.S. Pat. No. 7,052,725. Methods of producing treated water are known to those of ordinary skill in the art and include deionization, distillation, filtration and reverse osmosis (“r-o”), among others. The terms “treated water,” “purified water,”, “demineralized water,” “distilled water,” and “r-o water” are understood to be generally synonymous in this discussion, referring to water from which substantially all mineral content has been removed, typically containing no more than about 500 ppm total dissolved solids, e.g., 250 ppm total dissolved solids.

Those of ordinary skill in the art will understand that, for convenience, some ingredients are described here in certain cases by reference to the original form of the ingredient in which it is added to the beverage product formulation. Such original form may differ from the form in which the ingredient is found in the finished beverage product. Likewise, other ingredients identified as a solid or concentrate (e.g., juice concentrate), etc., would typically be homogenously dispersed throughout the beverage or throughout the beverage concentrate, rather than remaining in their original form. Thus, reference to the form of an ingredient of a beverage product formulation should not be taken as a limitation on the form of the ingredient in the beverage product, but rather as a convenient means of describing the ingredient as an isolated component of the product formulation.

Various sweeteners are included in the formulations of the beverages disclosed here. The sweeteners are edible consumables suitable for consumption and for use in beverages. By “edible consumables” is meant a food or beverage or an ingredient of a food or beverage for human or animal consumption. The sweetener or sweetening agent used here and in the claims can be nutritive, non-nutritive, natural or artificial depending on the particular embodiments (or mixtures of them) which provides sweetness to the beverage, i.e., which is perceived as sweet by the sense of taste. The perception of flavoring agents and sweetening agents may depend to some extent on the interrelation of elements. Flavor and sweetness may also be perceived separately, i.e., flavor and sweetness perception may be both dependent upon each other and independent of each other. For example, when a large amount of a flavoring agent is used, a small amount of a sweetening agent may be readily perceptible and vice versa. Thus, the oral and olfactory interaction between a flavoring agent and a sweetening agent may involve the interrelationship of elements.

As used herein, a “non-nutritive sweetener” is one which does not provide significant caloric content in typical usage amounts, i.e., is one which imparts less than 5 calories per 8 oz. serving of beverage to achieve the sweetness equivalent of 10 degrees Brix of sugar. As used herein, “reduced calorie beverage” means a beverage having at least a 25% reduction in calories per 8 oz. serving of beverage as compared to the full calorie version, typically a previously commercialized full-calorie version. As used herein, a “low-calorie beverage” has fewer than 40 calories per 8 oz. serving of beverage. As used herein, “zero-calorie” or “diet” means having less than 5 calories per serving, e.g., per 8 oz. for beverages.

Sweeteners and combinations of sweeteners suitable for use in the various embodiments of the beverage products disclosed here are selected for the desired nutritional characteristics, taste profile, beverage mouth feel and other organoleptic factors. Natural sweeteners suitable for at least certain exemplary embodiments include, for example, sucrose, liquid sucrose, fructose, liquid fructose, glucose, liquid glucose, honey, glucose-fructose syrup from natural sources such as apple, chicory, honey, etc., e.g., high fructose corn syrup, invert sugar, sorbitol, mannitol, xylitol, glycyrrhizin, d-tagatose, erythritol, meso-erythritol, maltitol, maltose, lactose, fructo-oligosaccharides, Lo Han Guo extracts, Lo Han Guo juice concentrate, Lo Han Guo powder of mogroside v content from 2 to 99%, rebaudioside a, stevioside, other steviol glycosides, stevia rebaudiana extracts, xylose, arabinose, isomalt, lactitol, maltitol, trehalose, rhamnose, and ribose, and protein sweeteners such as monatin, thaumatin, monellin, brazzein, 1-alanine and glycine and the like or mixtures of them. Also, in at least certain exemplary embodiments of the beverages disclosed here, combinations of one or more nutritive sweeteners and/or one or more non-nutritive sweeteners are used to provide the sweetness and other aspects of desired taste profile and nutritive characteristics. It should also be recognized that certain such sweeteners will, either in addition or instead, act as tastents, masking agents or the like in various embodiments of the beverages disclosed here, e.g., when used in amounts below its (or their) sweetness perception threshold in the beverage in question.

In at least certain exemplary embodiments of the beverages disclosed here, the sweetener component can include nutritive, crystalline or liquid sweeteners such as sucrose, liquid sucrose, fructose, liquid fructose, glucose, liquid glucose, glucose-fructose syrup from natural sources such as apple, chicory, honey, etc., e.g., high fructose corn syrup, invert sugar, maple syrup, maple sugar, honey, brown sugar molasses, e.g., cane molasses, such as first molasses, second molasses, blackstrap molasses, and sugar beet molasses, sorghum syrup, Lo Han Guo juice concentrate, and/or others. Such sweeteners are present in at least certain exemplary embodiments in an amount of from about 0.1% to about 20% by weight of the beverage, such as from about 6% to about 16% by weight, depending upon the desired level of sweetness for the beverage. To achieve desired beverage uniformity, texture and taste, in certain exemplary embodiments of the beverage products disclosed here, standardized liquid sugars as are commonly employed in the beverage industry can be used. Typically such standardized sweeteners are free of traces of non-sugar solids which could adversely affect the flavor, color or consistency of the beverage.

Acid used in the beverages disclosed here can serve any one or more of several functions, including, for example, lending tartness to the taste of the beverage, enhancing palatability, increasing thirst quenching effect, modifying sweetness and acting as a mild preservative. Suitable acids are known and will be apparent to those skilled in the art given the benefit of this disclosure. Exemplary acids found to be suitable for use in some or all embodiments of the beverage products disclosed here include phosphoric, citric, tartaric, lactic acids, optionally other natural carboxylic acids, and mixtures of any of them. The acid can be used in solution form, for example, and in an amount sufficient to provide the desired pH of the beverage. Typically, for example, the one or more acids of the acidulant are used in amount, collectively, of from about 0.01% to about 1.0% by weight of the beverage, e.g., from about 0.05% to about 0.5% by weight of the beverage, such as 0.1% to 0.25% by weight of the beverage, depending upon the acidulant used, desired pH, other ingredients used, etc. The pH of at least certain exemplary embodiments of the beverages disclosed here can be a value within the range of from about 2.0 to about 5.0. The acid in certain exemplary embodiments enhances beverage flavor. Too much acid can impair the beverage flavor and result in sourness or other off-taste, while too little acid can make the beverage taste flat.

The particular acid or acids chosen and the amount used will depend, in part, on the other ingredients, the desired shelf life of the beverage product, as well as effects on the beverage pH, titratable acidity, and taste. In the formation of calcium-supplemented beverages, the presence of calcium salts increases the pH which requires additional acids to both assist the dissolution of the salt and maintain a desirable pH for stability. The presence of the additional acid in the beverage composition, which increases the titratable acidity of the composition, will result in a more tart or sour taste to the resulting beverage. It will be within the ability of those skilled in the art, given the benefit of this disclosure, to select a suitable acid or combination of acids and the amounts of such acids for the acidulant component of any particular embodiment of the beverage products disclosed here.

Cola and other similar beverages typically exhibit a dark brown color derived from caramel coloring. Caramel is the dark brown material resulting from carefully controlled heat treatment of food grade carbohydrates, and therefore is known as “burnt sugar color.” There are four classes of caramel, classified by the inclusion of or processing with additional reactants. Caramel class I is plain caramel with no added reactants. In order to darken the color of caramel, artificial reactants such as caustic sulfite and/or ammonia can be added. Caramel class II is caramel that has been processed with caustic sulfite. Caramel class III is caramel that has been processed with ammonia. Caramel class IV is caramel that has been processed with both caustic sulfite and ammonia, and is currently used in the beverage industry to impart a dark brown color to cola beverages. All four classes of caramel are exemplary colorants found to be suitable for the beverages disclosed here. It will be within the ability of those skilled in the art, given the benefit of this disclosure, to select suitable additional or alternative colorants for use in various embodiments of the beverage products disclosed here.

Certain exemplary embodiments of the beverage products disclosed here also may contain small amounts of buffering agents to adjust pH. Such agents include, e.g., the potassium, sodium, or calcium salts of citric, malic, tartaric, lactic, ascorbic, glutaric, fumaric, gluconic, succinic, maleic and adipic acids, and mixtures of any of them. The amount included will depend, of course, on the type of buffering agents and on the degree to which the pH is to be adjusted.

The beverage products disclosed here optionally contain additional ingredients, including, for example, flavorings such as natural or artificial fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. The term berry also is used here to include aggregate fruits, i.e., not “true” berries, but fruit commonly accepted as such. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime, tangerine, mandarin orange, tangelo, pomelo, and grapefruit, and such flavors as apple, grape, cherry, and pineapple flavors and the like, and mixtures thereof. In certain exemplary embodiments the beverage concentrates and beverages comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots and leaves. Examples of such flavors include cola flavors, tea flavors, coffee flavors and the like, and mixtures thereof. The flavor component can further comprise a blend of several of the above-mentioned flavors. In certain exemplary embodiments of the beverage concentrates and beverages a cola flavor component is used or a tea flavor component. The particular amount of the flavor component useful for imparting flavor characteristics to the beverages of the present invention will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Juices suitable for use in at least certain exemplary embodiments of the beverage products disclosed here include, e.g., fruit, vegetable and berry juices. Juices can be employed in the present invention in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices can be combined, optionally along with other flavorings, to generate a beverage having the desired flavor. Examples of suitable juice sources include plum, prune, date, currant, fig, grape, raisin, cranberry, pineapple, peach, banana, apple, pear, guava, apricot, saskatoon berry, blueberry, plains berry, prairie berry, mulberry, elderberry, barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, litchi, lemon, orange, lime, tangerine, mandarin orange, tangelo, pomelo, and grapefruit etc. Numerous additional and alternative juices suitable for use in at least certain exemplary embodiments will be apparent to those skilled in the art given the benefit of this disclosure. In the beverages of the present invention employing juice, juice may be used, for example, at a level of at least about 0.2% by weight of the beverage. In certain exemplary embodiments juice is employed at a level of from about 0.2% to about 40% by weight of the beverage. Typically, juice can be used, if at all, in an amount of from about 1% to about 20% by weight.

Certain such juices which are lighter in color can be included in the formulation of certain exemplary embodiments to adjust the flavor and/or increase the juice content of the beverage without darkening the beverage color. Examples of such juices include apple, pear, pineapple, peach, lemon, lime, orange, apricot, grapefruit, tangerine, rhubarb, cassis, quince, passion fruit, papaya, mango, guava, litchi, kiwi, mandarin, coconut, and banana. Deflavored and decolored juices can be employed if desired.

Other flavorings suitable for use in at least certain exemplary embodiments of the beverage products disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings can be in the form of an extract, oleoresin, juice concentrate, bottler's base, or other forms known in the art. In at least certain exemplary embodiments, such spice or other flavors complement that of a juice or juice combination.

The one or more flavorings can be used in the form of an emulsion. A flavoring emulsion can be prepared by mixing some or all of the flavorings together, optionally together with other ingredients of the beverage, and an emulsifying agent. The emulsifying agent may be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. The emulsifier in exemplary embodiments comprises greater than about 3% of the mixture of flavorings and emulsifier. In certain exemplary embodiments the emulsifier is from about 5% to about 30% of the mixture.

Carbon dioxide is used to provide effervescence to certain exemplary embodiments of the beverages disclosed here. Any of the techniques and carbonating equipment known in the art for carbonating beverages can be employed. Carbon dioxide can enhance the beverage taste and appearance and can aid in safeguarding the beverage purity by inhibiting and destroying objectionable bacteria. In certain embodiments, for example, the beverage has a CO₂ level up to about 6.0, e.g. about 4.7 volumes carbon dioxide. Typical embodiments may have, for example, from about 0.5 to 5.0, e.g. 4.0 volumes of carbon dioxide. As used here and independent claims, one volume of carbon dioxide is defined as the amount of carbon dioxide absorbed by any given quantity of water at 32° F. (0° C.) and atmospheric pressure. A volume of gas occupies the same space as does the water by which it is absorbed. The carbon dioxide content can be selected by those skilled in the art based on the desired level of effervescence and the impact of the carbon dioxide on the taste or mouth feel of the beverage. The carbonation can be natural or synthetic.

Optionally, caffeine can be added to various embodiments of the beverages disclosed here. The amount of caffeine added is determined by the desired beverage properties, any applicable regulatory provisions of the country where the beverage is to be marketed, etc. In certain exemplary embodiments caffeine is included at a level of 0.02 percent or less by weight of the beverage. The caffeine must be of a purity acceptable for use in foods and beverages. The caffeine can be natural in origin or artificial

The beverage concentrates and beverages disclosed here optionally may contain other additional ingredients, including, generally, any of those typically found in beverage formulations. These additional ingredients, for example, can typically be added to a stabilized beverage concentrate. Examples of such additional ingredients include, but are not limited to, caramel class I-IV and concentrated apple extract and other natural colorants, antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including vitamins A, D, E (tocopherol), C (ascorbic acid), B (thiamine), B₂ (riboflavin), B₆, B₁₂, and K, niacin, folic acid, biotin, and combinations thereof. The optional non-mineral nutritional supplements are typically present in amounts generally accepted under good manufacturing practices. Exemplary amounts are between about 1% and about 100% RDV, where such RDV are established. In certain exemplary embodiments the non-mineral nutritional supplement ingredient(s) are present in an amount of from about 5% to about 20% RDV, where established.

The composition may be combined with preservatives. Examples include but are not limited to EDTA, sodium hexametaphosphate or other polyphosphates, other chelating agents, control of water hardness, carbon dioxide, pH, antimicrobial acidulants, other compounds with antimicrobial activity such as lauric arginate, or other physical methods of preservation (e.g., heat or ozone treatment). Additional methods of beverage preservation suitable for at least certain exemplary embodiments of the beverage products disclosed here include, e.g., aseptic packaging and/or heat treatment or thermal processing steps, such as hot filling and tunnel pasteurization.

### EXAMPLES

The following examples are specific embodiments of the present invention but are not intended to limit it.

### Example 1

Table 1 shows the inhibition of light-induced benzoate degradation with benzoate, sorbate and cinnamate blend preservative systems.

TABLE 1

| | | Flavored Beverage Model System | | | |
|---|---|---|---|---|---|
| | | | | | % Reduction in benzene |
| Flavored Beverage | | Potassium | Potassium | Potassium | formation after 8 h |
| Model System | | Benzoate | Sorbate | Cinnamate | exposure to Xenon |
| Ingredient | g/L | (ppm) | (ppm) | (ppm) | Arc Lamp at 86 F. |
| Potassium citrate*H20 | 0.2 | 162 | 0 | 0 | Control |
| Flavor emulsion | 2.0 | 162 | 162 | 0 | 84 |
| Phosphoric acid 100% | 0.4 | 162 | 100 | 0 | 75 |
| Citric acid | 0.3 | 162 | 100 | 50 | 84 |
| Water to volume | | 100 | 95 | 50 | 87 |
| pH = 3.0 | | 100 | 95 | 25 | 86 |
| | | 60 | 40 | 50 | 86 |
| | | 60 | 40 | 25 | 85 |

Specifically Table 1 data demonstrates that a 1:1 ratio of potassium benzoate to potassium sorbate adequately inhibits benzoate degradation. Ratios of benzoate to sorbate greater than 1:1 are also very effective at inhibiting benzoate degradation. The addition of potassium cinnamate in the 25-50 mg/L range to the benzoate and sorbate blends: 1) further improves benzoate stability; and 2) further improves preservative efficacy, a function of cinnamic acid's known preservative activity.

Table 2 shows the inhibition of heat- and light-induced benzoate degradation with benzoate, sorbate and cinnamate blend preservative systems.

TABLE 2
Flavored Beverage Model System

| | | | % Reduction in benzene | |
|---|---|---|---|---|
| Potassium | Potassium | Potassium | formation after 8 h | % Reduction in benzene |
| Benzoate | Sorbate | Cinnamate | exposure to Xenon Arc | formation after 48 h |
| (ppm) | (ppm) | (ppm) | Lamp at 86 F. | exposure to 140 F. |
| 162 | 0 | 0 | Control | Control |
| 162 | 50 | 0 | 58 | 4 |
| 162 | 50 | 62 | 82 | 55 |

Table 2 data demonstrates the benzoate/sorbate/cinnamate blend preservative system inhibits both heat- and light-induced benzoate degradation.

Table 3 shows the inhibition of heat- and light-induced benzoate degradation by conjugated diene containing compounds other than sorbate and cinnamate.

TABLE 3

| | | | % reduction in |
|---|---|---|---|
| | K | | benzene formation after 8 h |
| Conjugated | Benzoate | Conjugated Diene | exposure to Xenon Arc |
| Diene | (ppm) | (equimolar, ppm) | Lamp at 86 C. |
| Control | 162 | 0 | Control |
| K Sorbate | 162 | 50 | 53 |
| K Cinnamate | 162 | 62 | 45 |
| Hinokitiol | 162 | 50 | 64 |
| Resveratrol | 162 | 76 | 69 |

Table 3 demonstrates that the conjugated diene system is effective in stabilizing benzoate degradation and that addition of conjugated dienes other than sorbate and cinnamate to the preservative blend will further improve benzoate stabilization.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) In this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

What is claimed is:

1. A beverage product comprising at least a preservative system comprising 20-250 mg/L benzoic acid or salt thereof, 20-250 mg/L sorbic acid or salt thereof, and 10-100 mg/L cinnamic acid or salt thereof where the benzoic acid or salt thereof to sorbic acid or salt thereof mass ratio is greater than 1:1 while the mass ratio of benzoic acid or salt thereof to the total sorbic and cinnamic acid or salts thereof is approximately 1 or less.

2. The beverage product of claim 1 wherein the preservative blend comprises 60-200 mg/L benzoic acid or salt thereof, 40-200 mg/L sorbic acid or salt thereof, and 20-75 mg/L cinnamic acid or salt thereof where the benzoic acid or salt thereof to sorbic acid or salt thereof mass ratio is greater than 1:1 while the mass ratio of benzoic acid or salt thereof to the total sorbic and cinnamic acid or salts thereof is approximately 1 or less.

3. The beverage product of claim 1 wherein the preservative blend comprises 60-170 mg/L benzoic acid or salt thereof, 40-170 mg/L sorbic acid or salt thereof, 25-50 mg/L cinnamic acid or salt thereof where the benzoic acid or salt thereof to sorbic acid or salt thereof mass ratio is greater than 1:1 while the mass ratio of benzoic acid or salt thereof to the total sorbic and cinnamic acid or salts thereof is approximately 1 or less.

4. The beverage product of claim 1 comprising sodium or potassium benzoate, sodium or potassium sorbate, and potassium or sodium cinnamate.

5. The beverage product of claim 1 comprising potassium benzoate, potassium sorbate, and potassium cinnamate.

6. The beverage product of claim 1 wherein the mass ratio of benzoate to sorbate is 7-1.5:1.

7. The beverage product of claim 6 wherein the benzoate is selected from sodium benzoate, potassium benzoate or benzoic acid.

8. The beverage product of claim 1 having a pH of from about 2.0 to about 5.0.

9. The beverage product of claim 1 further comprising carbonated water.

10. The beverage product of claim 1 further comprising a nutritive or non-nutritive sweetener or sweetener blend.

11. The beverage product of claim 1 further comprising a flavoring.

12. The beverage product of claim 1 further comprising an acidulant.

13. The beverage product of claim 1 further comprising at least one of a buffer, juice, emulsion, and caffeine.

14. A method of preparing a beverage product comprising including in the beverage a preservative system comprising 20-250 mg/L benzoic acid or salt thereof, 20-250 mg/L sorbic acid or salt thereof, and 10-100 mg/L cinnamic acid or salt thereof where the benzoic acid or salt thereof to sorbic acid or salt thereof mass ratio is greater than 1:1 while the mass ratio of benzoic acid or salt thereof to the total sorbic and cinnamic acid or salts thereof is approximately 1 or less.

15. The method of claim 14 wherein the preservative blend comprises 60-200 mg/L benzoic acid or salt thereof, 40-200 mg/L sorbic acid or salt thereof, and 20-75 mg/L cinnamic acid or salt thereof where the benzoic acid or salt thereof to sorbic acid or salt thereof mass ratio is greater than 1:1 while the mass ratio of benzoic acid or salt thereof to the total sorbic and cinnamic acid or salts thereof is approximately 1 or less.

16. The method of claim 14 wherein the preservative blend comprises 60-170 mg/L benzoic acid or salt thereof, 40-170 mg/L sorbic acid or salt thereof, 25-50 mg/L cinnamic acid or salt thereof where the benzoic acid or salt thereof to sorbic acid or salt thereof mass ratio is greater than 1:1 while the mass ratio of benzoic acid or salt thereof to the total sorbic and cinnamic acid or salts thereof is approximately 1 or less.

17. The method of claim 14 wherein the preservative blend comprises sodium or potassium benzoate, sodium or potassium sorbate, and potassium or sodium cinnamate.

18. The method of claim 14 wherein the preservative blend comprises potassium benzoate, potassium sorbate, and potassium cinnamate.

19. The method of claim 14 wherein the mass ratio of benzoate to sorbate is 7-1.5:1.

20. The method of claim 19 wherein the benzoate is selected from sodium benzoate, potassium benzoate or benzoic acid.

21. A method of inhibiting heat- or light-induced formation in a benzoate-preserved beverage comprising preparing a beverage product comprising 20-250 mg/L benzoic acid or salt thereof, 20-250 mg/L sorbic acid or salt thereof, and 10-100 mg/L cinnamic acid or salt thereof where the benzoic acid or salt thereof to sorbic acid or salt thereof mass ratio is greater than 1:1 while the mass ratio of benzoic acid or salt thereof to the total sorbic and cinnamic acid or salts thereof is approximately 1 or less.

22. The method of claim 21 wherein the preservative blend comprises 60-200 mg/L benzoic acid or salt thereof, 40-200 mg/L sorbic acid or salt thereof, and 20-75 mg/L cinnamic acid or salt thereof where the benzoic acid or salt thereof to sorbic acid or salt thereof mass ratio is greater than 1:1 while the mass ratio of benzoic acid or salt thereof to the total sorbic and cinnamic acid or salts thereof is approximately 1 or less.

23. The method of claim 21 wherein the preservative blend comprises 60-170 mg/L benzoic acid or salt thereof, 40-170 mg/L sorbic acid or salt thereof, 25-50 mg/L cinnamic acid or salt thereof where the benzoic acid or salt thereof to sorbic acid or salt thereof mass ratio is greater than 1:1 while the mass ratio of benzoic acid or salt thereof to the total sorbic and cinnamic acid or salts thereof is approximately 1 or less.

24. The method of claim 21 wherein the preservative blend comprises sodium or potassium benzoate, sodium or potassium sorbate, and potassium or sodium cinnamate.

25. The method of claim 21 wherein the preservative blend comprises sodium or potassium benzoate, sodium or potassium sorbate, and potassium or sodium cinnamate.

26. The method of claim 21 wherein the preservative blend comprises potassium benzoate, potassium sorbate, and potassium cinnamate.

27. The method of claim 21 wherein the benzoate to sorbate mass ratio is 7-1.5:1.

28. The method of claim 27 wherein the benzoate is selected from sodium benzoate, potassium benzoate or benzoic acid.

29. The beverage product of claims 1-13, the method of preparing a beverage product of claims 14-20, and the method of inhibiting heat- or light-induced benzene formation in claims 21-28 wherein additional conjugated dienes may be used to further stabilize benzoate or further reduce or eliminate the sorbate or cinnamate concentrations while maintaining benzoate stability. These conjugated dienes include, but are not limited to, aliphatic conjugated dienes and salts or derivatives thereof such as 2,4-pentadienoic acid, 2,4-heptadienoic acid, 3,5-heptadienoic acid, and conjugated linoleic acid; phenylpropenoic acids and salts or derivatives thereof such as caffeic acid, para-coumaric acid, ferulic acid, and sinapic acid; and other dieneoic acids and salts and derivatives thereof such as 2-furanacrylic acid, uracanic acid, retinoic acid, 3-(3-pyr) acrylic acid, and 3-(4-pyr) acrylic acid; as well as, and in particular, aromatic conjugated diene-containing compounds such as hinokitiol and resveratrol.
